(19) United States
(12) Patent Application Publication
(10) Pub. No.: US 2008/0011066 A1
(43) Pub. Date: Jan. 17, 2008

(54) ATOMIC FORCE MICROSCOPE CANTILEVER AND METHOD FOR MANUFACTURING THE SAME

(75) Inventors: Moon Suhk Suh, Gyeonggi-do (KR); Jin-Koog Shin, Seoul (KR); Churl Seung Lee, Gyeonggi-do (KR); Kyoung Il Lee, Seoul (KR)

Correspondence Address: GREENBLUM & BERNSTEIN, P.L.C., 1950 ROLAND CLARKE PLACE, RESTON, VA, 20191, US

(73) Assignee: KOREA ELECTRONICS TECHNOLOGY INSTITUTE, Seongnam-si (KR)

(21) Appl. No.: 11/614,492

(22) Filed: Dec. 21, 2006

(30) Foreign Application Priority Data
Jul. 14, 2006 (KR) 10-2006-0066245

(51) Int. Cl. G01B 5/28

(52) U.S. Cl. 73/105

(57) ABSTRACT

The present invention relates to various types of atomic force microscope (AFM) cantilevers formed by using a photolithography process and an etching process and a method for manufacturing the same, the AFM cantilever includes a handling unit made of a semiconductor substrate, a cantilever unit extendedly formed on a bottom surface of the handling unit in a shape of a rod, a probe unit formed in a shape of a vertically protruded peak by being extendedly formed on one side surface of the cantilever unit and a probe being in contact with a surface of an object to be analyzed by being formed on the peak of the probe unit. Therefore, the present invention has an advantage that the probe of several hundred nanometers can easily formed through a general photolithography process as well as it can easily obtain a natural resonance frequency of the designed cantilever by easily setting a thickness of the cantilever member.

### BACKGROUND OF THE INVENTION

1. Field of the Invention

The present invention relates to an atomic force microscope (AFM) cantilever and a method for manufacturing the same; and, more particularly, to various types of AFM cantilevers formed by using a photolithography process and an etching process and a method for manufacturing the same.

2. Background of the Related Art

A probe member of an atomic force microscope (AFM) has a sharp shape. Such probe member is formed in a sharp shape by wet etching or dry etching a general semiconductor substrate.

The probe member formed through the wet etching becomes a pyramid shape and the probe member formed through a dry etching becomes a cone shape.

In addition, recently by growing or adhering a carbon nano-tube on a peak unit of the probe member, a probe having a high aspect-ratio with a very long length and a very small bottom area has been developed.

On the other hand, as a cantilever has been developed so as to measure a side wall of the etched portion by specifically fabricating end portions of the probe for accurately obtaining a sidewall image of the portion etched in the semiconductor process, the AFM can be applied to various fields.

However, in order to practically use such conventional AFM cantilever, there are various problems as follow.

At first, in case when a wet etching is performed to form the cantilever structure, it is very difficult to obtain a natural resonance frequency of the cantilever in design since a thickness of the cantilever has a great difference between a top portion and a bottom portion. And also, in order to make an end portion of the cantilever in a shape of “V”, in an initial photo-lithography process, it is required for an accurate photo-lithography process to allow the cantilever pattern to have a specific angle with reference to a wafer cutting surface. If the angle in the photo-lithography process is tilted, a desired shape of the probe cannot be formed by exposing the etching cross-section exposed to the end portion of the cantilever in a different crystal direction.

And also, after the photo-lithography process is implemented in a state of forming an accurate angle, a desired inclined surface can be formed through various additional photo-lithography processes when the silicon is wet etched. This becomes the most critical problem in manufacturing the cantilever.

This problem causes the increment of product cost, reduction of a yield, and very low manufacturing reliability.

Secondly, since the cantilever probe member in a shape of a pyramid or a cone does not have a sharp end portion, it is very difficult to read an accurate charge at a desired place by reading data in a broad range when the cantilever probe member scans nanometer regions. Therefore, a resolution becomes low.

Thirdly, desired information can be obtained by only vertically erecting the cantilever when the cantilever accesses a sample where the charges are distributed.

Fourthly, in case when the cantilever for scanning a high aspect ratio region or the cantilever for scanning the sidewall image of the etched portion can be manufactured, the probe member is fabricated again through an additional process. Accordingly, there are problems that a cost becomes very high and the efficiency of the production is deteriorated.

### SUMMARY OF THE INVENTION

### Technical Problem

It is, therefore, an object of the present invention to provide various types of atomic force microscope (AFM) cantilever and a method for manufacturing the same.

It is another object of the present invention to provide a method for forming a fine probe of several to several hundreds nano scales by using a conventional photolithography process.

It is further another object of the present invention to provide a method for forming a probe having a high aspect ratio without an additional special fabrication process.

It is still another object of the present invention to provide a cantilever capable of easily scanning a surface of a sample without vertically erecting the cantilever when the cantilever accesses the electric charge distributed sample and a method for manufacturing the same.

### Technical Solution

In accordance with an aspect of the present invention, there is provided an atomic force microscope (AFM) cantilever, including: a handling unit made of a semiconductor substrate; a cantilever unit extendedly formed on a bottom surface of the handling unit in a shape of a rod; a probe unit formed in a shape of a vertically protruded peak by being extendedly formed on one side surface of the cantilever unit; and a probe being in contact with a surface of an object to be analyzed by being formed on the peak of the probe unit.

It is preferable that the semiconductor substrate is a silicon-on-insulator (SOI) substrate or a separation by implanted oxygen (SIMOX) substrate.

It is preferable that the probe is a structure having a high aspect ratio of several to several hundreds nanometer width, the probe is a structure that both side surfaces are protruded, and the probe is bent from a center of the probe unit at a predetermined angle ranging from 12° to 20°.

In accordance with another aspect of the present invention, there is provided a method for manufacturing an atomic force microscope (AFM) cantilever, the method including the steps of: a first step of forming a multi-layer insulating layer on a top of a substrate where an inter-layer insulating layer and a second semiconductor substrate are sequentially formed on a top of a first semiconductor substrate; a second step of forming a probe and a probe unit pattern on a top of the multi-layer insulating layer; a third step of etching the multi-layer insulating layer, the second semiconductor substrate and the inter-layer insulating layer sequentially; a fourth step of forming the probe and the probe unit by selectively etching the first semiconductor substrate; a fifth step of forming a cantilever unit pattern on a one side end portion of the formed probe unit; a sixth step of forming the cantilever unit by sequentially etching the remaining multi-layer insulating layer, the first semiconductor substrate, the inter-layer insulating layer and the second semiconductor substrate; a seventh step of forming a photoresist passivation layer on a front surface and a rear surface by coating a photoresist layer on the front surface and the rear surface of the semiconductor substrate; an eighth step of forming a handling unit pattern by patterning the photoresist passivation layer formed on the rear surface of the second semiconductor substrate; a ninth step of etching the second semiconductor substrate by using the handling unit pattern; and a tenth step of removing the photoresist passivation existing on the front surface and the rear surface of the substrate.

It is preferable that the multi-layer insulating layer is formed by alternately depositing a silicon oxide layer and a silicon nitride layer.

It is preferable that the etching of the multi-layer insulating layer of the third step utilizes a selective wet etching and the fourth step utilizes the selective wet etching so as to release the probe.

It is preferable that a thermal oxidation process is further included between the fourth step and the fifth step to form the probe more fine and sharp.

It is preferable that the sixth step etches the first semiconductor substrate, the inter-layer insulating layer and the second semiconductor substrate with a thickness corresponding to a width of the cantilever.

It is preferable that the wet etching of the first semiconductor substrate utilizes K₂O or tetramethyl ammonium hydroxide (TMAH).

### BRIEF DESCRIPTION OF THE DRAWINGS

FIG. 1 is a perspective view showing an atomic force microscope (AFM) cantilever in accordance with an embodiment of the present invention;

FIG. 2 is a cross-sectional diagram depicting the AFM cantilever in accordance with the embodiment of the present invention; and

FIGS. 3a to 31 are manufacturing process diagrams of the AFM in accordance with the embodiment of the present invention.

### DETAILED DESCRIPTION OF THE INVENTION

Hereinafter, a preferred embodiment of the present invention will be described in detail with reference to the accompanying drawings. Above all, terms or words used in the specification and claims are not limited to usual or encyclopedical meaning, but the present invention should be understood by the meaning or concept matching to the technical sprits of the present invention on the basis of such principles that the scope of the term can be properly defined to explain the present invention with the best method by the inventor.

Accordingly, since the embodiments described in the present specification and construction described on the accompanying drawings are only the preferred embodiments, but do not represent for all technical aspects of the present invention, it should be understood that various equivalents and modification examples exist for replacing with the technical aspects of the present invention at the time of filing the present invention.

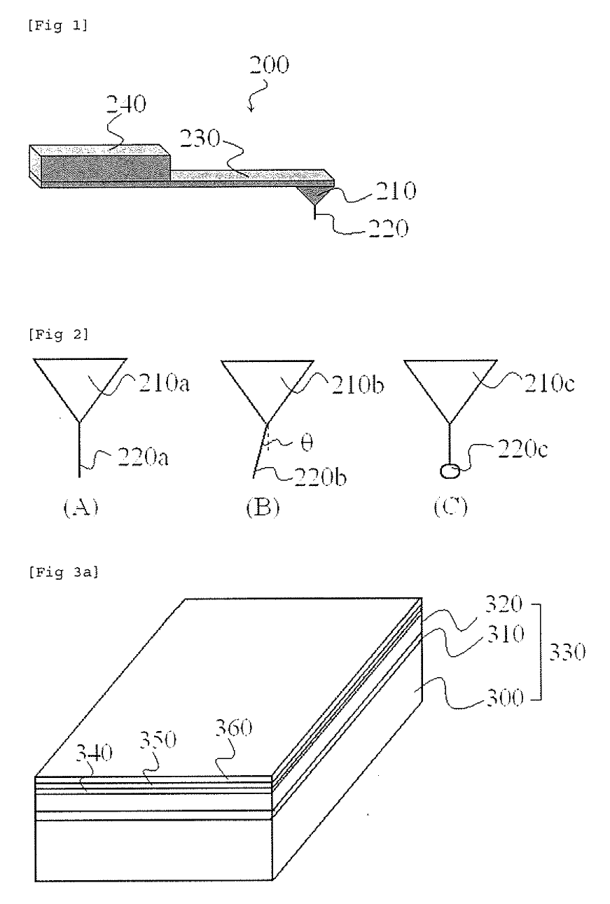

A perspective view showing an atomic force microscope (AFM) cantilever in accordance with an embodiment of the present invention is shown in FIG. 1. The AFM cantilever 200 in accordance with the embodiment of the present invention includes a handling member 240 made of a semiconductor substrate, a cantilever member 230 extendedly formed on a bottom surface of the handling member 240 in a shape of a rod, a probe member 220 made of a vertically protruded peak shape by being extendedly formed on one side surface of the cantilever unit 230 and a probe 210 being in contact with a surface of an object to be analyzed by being formed on a peak of the probe member 220. That is, the probe 210, the probe member 220, the cantilever member 230 and the handling member 240 are formed with extending from each side surface, and the probe member 220 and the probe 210 are formed on one side end of the cantilever member 230 in place of the center of the cantilever member 230 differently from the prior art.

And also, a shape of the AFM cantilever 200 in accordance with the embodiment of the present invention can be made of various shapes such as a probe 210a formed vertically to a center of a probe member 220a with a high aspect ration structure of several to several hundreds nanometer width as shown in FIG. 2A, a probe 210a bent from a center of a probe member 220a at a predetermined angle θ ranging from 12° to 20°with a high aspect ration structure as shown in FIG. 2B, and a probe 210a formed with a structure protruded from both side surfaces as shown in FIG. 2C.

Among these, the probe 210a with a shape of a predetermined angle from a center of a probe member 220a has an advantage of increasing an accuracy of a sample analysis as being designed based on a phenomenon of being in contact with a surface of an object to be analyzed with making the probe 210a of a cantilever bent at an angle of approximately 15° in measuring the sample by applying it to a practical atomic force microscope, whereas the probe 210a in a shape protruded from both side surfaces of the probe 210a has an advantage that it easily analyzes both side surfaces of the structure having a groove with a high aspect ratio.

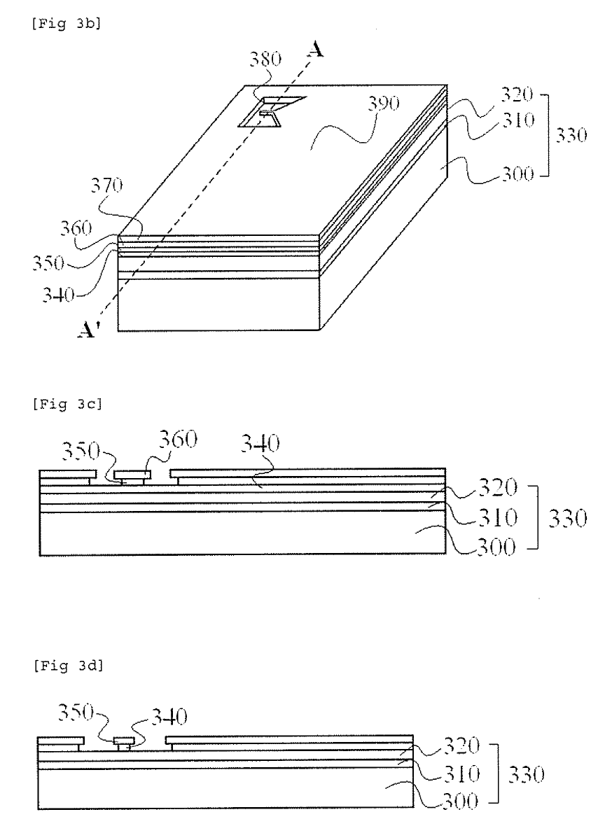

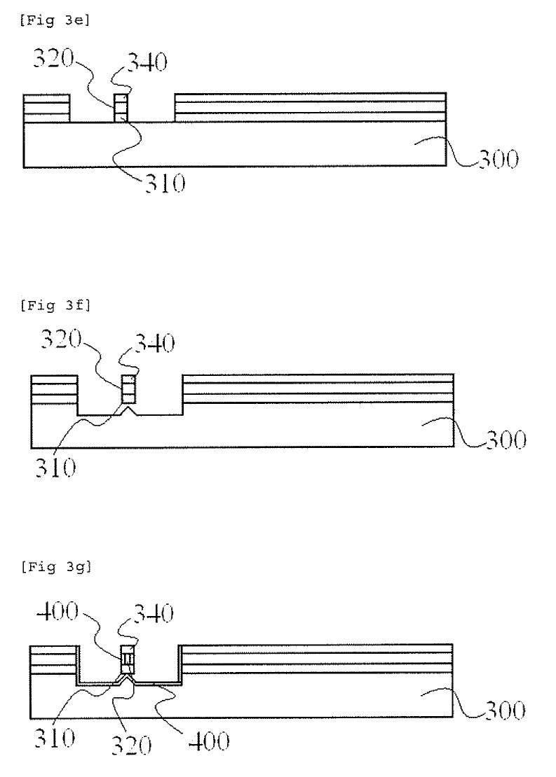

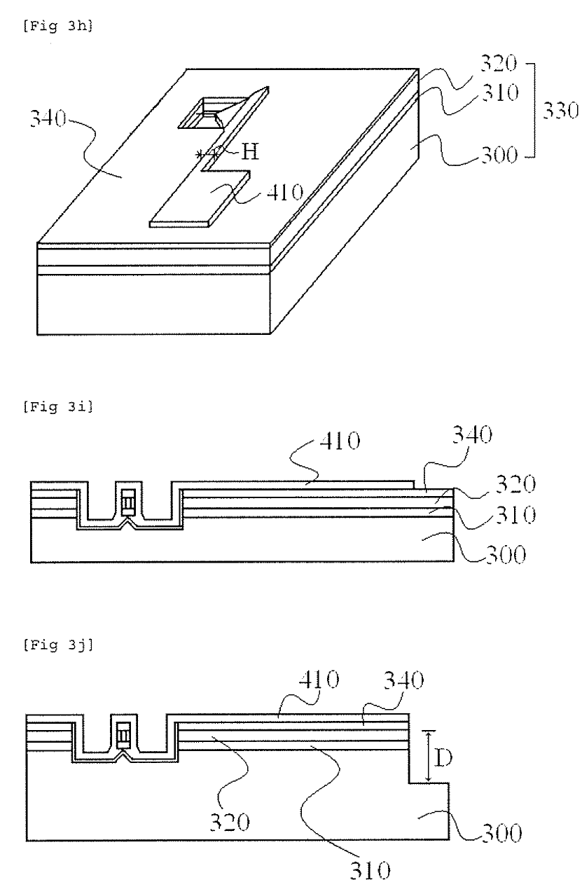

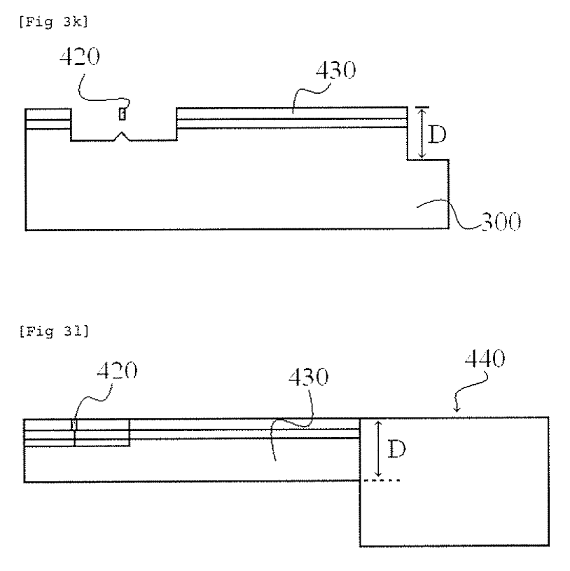

Hereinafter, a manufacturing process of the AFM cantilever will be described in detail as follows with reference to the accompanying FIGS. 3a to 31.

At first, an inter-layer insulating layer 310 and a second semiconductor substrate 320 are formed on a top of a first semiconductor substrate 300 as shown in FIG. 3a.

In the embodiment of the present invention, in place of formation processes of the first semiconductor substrate 300, the inter-layer insulating layer 310 and the second semiconductor substrate 320, the first semiconductor substrate 300 can be made of a single crystal bulk silicon, the inter-layer insulating layer 310 can be made of a silicon oxide layer and the second semiconductor substrate 320 can be formed by applying a silicon-on-insulator (SOI) substrate made of poly crystal silicon or amorphous silicon or by applying a separation by implanted oxygen (SIMOX) substrate.

Thereafter, a multi-layer insulating layer is formed on a top of the second semiconductor substrate 320. The multi-layer insulating layer can be formed by alternately depositing a silicon oxide layer and a silicon nitride layer.

In one embodiment of the present invention, as shown in FIG. 3a, the multi-layer insulating layer composed of a first silicon oxide layer 340, a first silicon nitride layer 350 and a second silicon oxide layer is formed on a top of the second semiconductor substrate 320.

At this time, it is very important that the semiconductor substrates can be protected from a following process such as an etching process by forming the first silicon oxide layer 340 thick more than approximately 2.5 times in comparison with a thickness of the inter-layer insulating layer 310.

The first silicon oxide layer 340 is formed by using a chemical vapor deposition (hereinafter referring to as “CVD”) or a thermal oxidation method, a first silicon nitride layer 350 is formed by a CVD, a low pressure chemical vapor deposition (hereinafter referring to as “LPCVD”), a plasma-enhanced chemical vapor deposition (hereinafter referring to as “PECVD”), and the second silicon oxide layer 350 is formed through a CVD process.

On the other hand, in case when the first silicon oxide layer 340 is formed through a thermal oxidation method, the first silicon oxide layer 340 can be formed on a top of the semiconductor substrate as well as a bottom of the semiconductor substrate; and, in case when the first silicon nitride layer 350 is formed by using an LPCVD, the first silicon nitride layer can be formed on a bottom of the semiconductor substrate as described above

If the formation process of the multi-layer insulating layer is finished, a formation process of the probe member pattern is performed so as to form the probe member on a top of the substrate formed thereon the insulating layer, as shown in FIG. 3b.

More particularly, after a photoresist layer is formed on a top of the multi-layer insulating layer, a photoresist pattern 370 is formed so as to form the probe member and the probe by performing a photolithography process.

In accordance with one embodiment of the present invention, the photoresist layer can employ a negative photoresist layer, and the photoresist layer pattern is formed so as to expose regions 380 excepting regions where the probe member and the probe are formed. Together with this, the present invention makes the following formation processes of the cantilever member further easy by forming the photoresist pattern to protect the additional region 360 adjacent to the region to form the probe member.

At this time, the photoresist pattern 370 to form the probe member and the probe can be applied with various shapes. The pattern to form the probe as shown in FIG. 2 can be easily formed by using a photolithography process

That is, the present invention has an advantage that the probe can be easily manufactured for matching with various application fields without limitations of processes by freely controlling the shapes of the probe member and the probe.

After a process of forming a photoresist layer pattern 370 to form a probe and a probe member is performed, the multi-layer insulating layer existing at a bottom thereof is sequentially etched by using the photoresist layer pattern 370.

FIG. 3c represents a cross-section of FIG. 3b taken along a line A-A′.

As shown in FIG. 3c, after the second silicon oxide layer 360 corresponding to the most upper layer of the multi-layer insulating layer is etched, a first silicon nitride layer 350 is etched.

At this time, the etching of the second silicon oxide layer 360 uses a solution obtained by mixing an ultra pure water and fluoride, or can apply a wet etching using a buffered HF (BHF) or a buffered oxide etchant (BOE) obtained by mixing NH₄F and fluroide and can apply a dry etching using CF₄ gas, CHF₃ gas or the like which contains H or F. And, the first silicon nitride layer 350 performs a selective wet etching.

The first silicon nitride layer 350 etched as described above is etched until a portion of the bottom surface of the second silicon oxide layer 360 etched as shown in FIG. 3c. The pattern of the etched first silicon nitride layer 350 is formed in a smaller shape than that of the second silicon oxide layer 360, as shown in FIG. 3c.

Thereafter, a pattern of the first silicon oxide layer 340 having a smaller size than the etched first silicon nitride layer 350 is formed by performing a wet etching or a selective wet etching to the first silicon oxide layer 340 by using the etched silicon nitride layer 350, as shown in FIG. 3d. At this time, the remaining second silicon oxide layer 360 is removed.

A size of the probe existing at the end portions of the probe member can be formed with several to several hundreds nanometers by only using a photolithography process and an etching process as the above-described multi-layer insulating layer etching process causes the pattern to be reduced.

After the first silicon nitride layer 350 is removed by a wet etching using phosphate (H₃PO₄), the second semiconductor substrate 320 and the inter-layer insulating layer 310 are etched by using the etched first silicon oxide layer.

The etchings of the second semiconductor substrate 320 and the inter-layer insulating layer 310 are implemented by a dry etching using plasma. At this time, the first silicon oxide layer 340 is formed thick more than 2.5 times in comparison with the inter-layer insulating layer 310, in this result, the first silicon oxide layer 340 remains at a top portion of the second semiconductor substrate 320, as shown in FIG. 3e.

And, the first semiconductor substrate 300 existing at a bottom surface of the inter-layer insulating layer 310 is etched, as shown in FIG. 3f.

The etching of the first semiconductor substrate 300 is realized through a selective wet etching process. At this time, KO2 or tetramethylammonium hydroxide (TMAH) can be applied as the etching solution to be used.

Such etching solution can etch the substrates vertically as well as etch the substrate horizontally, thereby etching the first semiconductor substrate 300 in a shape as shown in FIG. 3f. In this result, the probe having a fine width is smoothly released from the first semiconductor substrate 300.

And, after a wet or dry thermal oxidation process is performed so as to form the probe more fine and sharp, as shown in FIG. 3g, a process to remove the formed thermal oxidation layer 400 can be added.

It is preferable that such wet or dry thermal oxidation process is performed by selecting an appropriate process according to a shape and a size of the desired probe. The thermal oxidation layer 400 can be removed through an additional etching process or it can be removed through a following etching process for forming the following cantilever member to be performed.

After the probe member and the probe are formed through the above-described serial processes, a cantilever pattern 410 is formed on a spare region 390 contacting with the region where the probe member is formed as shown in FIG. 3h. At this time, the cantilever pattern can be formed by being overlapped with end portions of the previously formed probe member.

The formation process of the cantilever pattern 410 can be easily performed by using a photolithography. During the formation of the cantilever member pattern 410, there is an advantage that a thickness (H) of the cantilever member can be easily controlled, as shown FIG. 3h.

Thereafter, the exposed first silicon oxide layer 340 is etched, and the cantilever member is formed by sequentially etching the second semiconductor substrate 320, the inter-layer insulating layer 310 and the first semiconductor substrate 300, as shown in FIG. 3j.

At this time, since the etched depth (D) becomes a width of the cantilever member, it is preferable that an etch depth is set by the width of the cantilever member.

And then, the remaining cantilever pattern 410, i.e., a photoresist layer pattern, is removed and a process of removing the first silicon oxide layer 340 is performed.

If the thermal oxidation layer 400 is formed so as to form the probe more accurately and sharply, the thermal oxidation layer 400 and the first silicon oxidation layer 340 can be simultaneously etched.

Accordingly, the probe 420 as shown in FIG. 3k, the probe member (not shown), and the cantilever member 430 can be formed.

The photoresist passivation layer is formed on a front surface and a rear surface of the substrate where the cantilever member formation process is performed.

It is preferable that the photoresist passivation layer formed on the front surface is formed thick enough to protect the probe, the probe member and the cantilever member previously formed from the etching process performed during the formation process of the handling member.

The photoresist layer pattern is formed to form the handling member by performing the photolithography process for the photoresist layer pattern formed on the rear surface.

And then, the semiconductor substrate, i.e., the first semiconductor substrate, is etched by a deep silicon etchant by using the formed photoresist layer pattern and it is etched until the photoresist layer passivation layer existing at the front surface is exposed.

If the rear surface etching of the first semiconductor substrate is finished, all the photoresist layer existing at the semiconductor substrate are removed.

The AFM cantilever 440 finally released through such serial processes can be obtained as shown in FIG. 31.

Therefore, the present invention can easily form the probe with a size of several hundred nanometers to several micrometers through only a simple photolithography process, and has an advantage that the probe and the cantilever member of a desired shape can be formed through the pattern formation process.

### Effect of the Invention

The method for manufacturing the AFM cantilever in accordance with the present invention has an advantage that the probe of several hundred nanometers can be easily formed through a general photolithography process as well as it can easily obtain a natural resonance frequency of the designed cantilever by easily setting a thickness of the cantilever member.

And also, the AFM cantilever in accordance with the present invention has an advantage that it can be applied to analyze samples under various conditions by having various shapes.

Further, the method for manufacturing the AFM cantilever in accordance with the present invention has an effect that the shapes of the probe can be easily designed and changed according to a desired condition by forming the probe with various shapes without an additional special fabrication process.

In addition, the present invention can improve a manufacturing process yield of the AFM cantilever and reduce the cost of the products by increasing the reliability thereof.

The present application contains subject matter related to Korean patent application no. 2003-79003, filed in the Korean Patent Office on Nov. 10, 2003, the entire contents of which being incorporated herein by reference.

While the present invention has been described with respect to certain preferred embodiments, it will be apparent to those skilled in the art that various changes and modifications may be made without departing from the scope of the invention as defined in the following claims.

What is claimed is:

1. An atomic force microscope (AFM) cantilever, comprising:
a handling unit made of a semiconductor substrate;
a cantilever unit extendedly formed on a bottom surface of the handling unit in a shape of a rod;
a probe unit formed in a shape of a vertically protruded peak by being extendedly formed on one side surface of the cantilever unit; and
a probe being in contact with a surface of an object to be analyzed by being formed on the peak of the probe unit.

2. The AFM cantilever as recited in claim 1, wherein the semiconductor substrate is a silicon-on-insulator (SOI) substrate or a separation by implanted oxygen (SIMOX) substrate.

3. The AFM cantilever as recited in claim 1, wherein the probe is a structure having a high aspect ratio of several to several hundreds.

4. The AFM cantilever recited in claim 1, wherein the probe is a structure that both side surfaces are protruded.

5. The AFM cantilever as recited in claim 3, wherein the probe is bent from a center of the probe unit at a predetermined angle.

6. The AFM cantilever as recited in claim 5, wherein the predetermined angle is ranging from 12° to 20°.

7. A method for manufacturing an atomic force microscope (AFM) cantilever, the method comprising the steps of:
a first step of forming a multi-layer insulating layer on a top of a substrate where an inter-layer insulating layer and a second semiconductor substrate are sequentially formed on a top of a first semiconductor substrate;
a second step of forming a probe and a probe unit pattern on a top of the multi-layer insulating layer;
a third step of etching the multi-layer insulating layer, the second semiconductor substrate and the inter-layer insulating layer sequentially;
a fourth step of forming the probe and the probe unit by selectively etching the first semiconductor substrate;
a fifth step of forming a cantilever unit pattern on a one side end portion of the formed probe unit;
a sixth step of forming the cantilever unit by sequentially etching the remaining multi-layer insulating layer, the second semiconductor substrate, the inter-layer insulating layer and the first semiconductor substrate;
a seventh step of forming a photoresist passivation layer by coating a photoresist layer on a front surface and a rear surface of the semiconductor substrate;
an eighth step of forming a handling unit pattern by patterning the photoresist passivation layer formed on the rear surface of the second semiconductor substrate;
a ninth step of etching the first semiconductor substrate by using the handling unit pattern; and
a tenth step of removing the photoresist passivation existing on the front surface and the rear surface of the substrate.

8. The method as recited in claim 7, wherein the multi-layer insulating layer is formed by alternately depositing a silicon oxide layer and a silicon nitride layer.

9. The method as recited in claim 7, wherein the etching of the multi-layer insulating layer of the third step utilizes a selective etching.

10. The method recited in claim 7, wherein the fourth step utilizes a selective wet etching so as to release the probe.

11. The method as recited in claim 7, further comprising a thermal oxidation process between the fourth step and the fifth step.

12. The method as recited in claim 7, wherein the sixth step etches the first semiconductor substrate, the inter-layer insulating layer and the second semiconductor substrate with a thickness corresponding to a width of the cantilever.

13. The method as recited in claim 10, wherein the wet etching utilizes K₂O or tetramethyl ammonium hydroxide (TMAH).
